(19) United States
(12) Patent Application Publication
(10) Pub. No.: US 2015/0006368 A1
(43) Pub. Date: Jan. 1, 2015

(54) INFORMATION PROCESSING DEVICE, INFORMATION PROCESSING METHOD, AND COMPUTER-READABLE MEDIUM

(71) Applicant: Fuji Xerox Co., Ltd., Tokyo (JP)

(72) Inventor: Noriaki TANAKA, Yokohama-shi (JP)

(73) Assignee: Fuji Xerox Co., Ltd., Tokyo (JP)

(21) Appl. No.: 14/184,901

(22) Filed: Feb. 20, 2014

(30) Foreign Application Priority Data
Jul. 1, 2013 (JP) 2013-137944

(51) Int. Cl. G06Q 20/22

(52) U.S. Cl. CPC G06Q 20/227
USPC 705/39

(57) ABSTRACT

An information processing device includes an information acquiring unit that, in the case in which a pay service is provided to a user, acquires fee calculation information used to calculate a fee for the service, a selecting unit that, in the case in which a plurality of payment methods exist for a fee calculated on the basis of fee calculation information acquired by the information acquiring unit, selects at least one payment method from among the plurality of payment methods, on the basis of influence information that potentially influences selection of the payment method, and a sending unit that sends, to a destination depending on the payment method selected by the selecting unit, charge information used to charge a fee calculated on the basis of the acquired fee calculation information.

### CROSS-REFERENCE TO RELATED APPLICATIONS

This application is based on and claims priority under 35 USC 119 from Japanese Patent Application No. 2013-137944 filed Jul. 1, 2013.

### BACKGROUND

### Technical Field

The present invention relates to an information processing device, an information processing method, and a computer-readable medium.

### SUMMARY

According to an aspect of the invention, there is provided an information processing device including an information acquiring unit that, in the case in which a pay service is provided to a user, acquires fee calculation information used to calculate a fee for the service, a selecting unit that, in the case in which multiple payment methods exist for a fee calculated on the basis of fee calculation information acquired by the information acquiring unit, selects at least one payment method from among the multiple payment methods, on the basis of influence information that potentially influences selection of the payment method, and a sending unit that sends, to a destination depending on the payment method selected by the selecting unit, charge information used to charge a fee calculated on the basis of the acquired fee calculation information.

### BRIEF DESCRIPTION OF THE DRAWINGS

Exemplary embodiments of the present invention will be described in detail based on the following figures, wherein:

FIG. 1 is a diagram illustrating an example of an overall configuration of an information processing system according to the first exemplary embodiment;

FIG. 2 is a diagram illustrating an example of a hardware configuration of an output device;

FIG. 3 is a diagram illustrating an example of a hardware configuration of an information processing device;

FIG. 4 is a diagram illustrating an example of a functional configuration of an information processing device and an output device;

FIG. 5 is a diagram illustrating an example of an image displayed when conducting a start operation;

FIG. 6 is a diagram illustrating an example of a facility table;

FIG. 7 is a diagram illustrating an example of a nearby collection agent table;

FIG. 8 is a diagram illustrating an example of a first priority ranking table;

FIG. 9 is a diagram illustrating an example of a second priority ranking table;

FIG. 10 is a diagram illustrating an example of a destination table;

FIG. 11 is a sequence diagram illustrating exemplary operation of respective devices in a charge process;

FIG. 12 is a sequence diagram illustrating exemplary operation of respective devices in a charge process;

FIG. 13 is a sequence diagram illustrating exemplary operation of respective devices in a charge process;

FIG. 14 is a sequence diagram illustrating exemplary operation of respective devices in a charge process;

FIG. 15 is a sequence diagram illustrating exemplary operation of respective devices in a charge process;

FIG. 16 is a diagram illustrating an example of a functional configuration of an information processing device and an output device according to the second exemplary embodiment;

FIGS. 17A and 17B are diagrams illustrating an example of a third priority ranking table;

FIG. 18 is a diagram illustrating an example of a fourth priority ranking table;

FIG. 19 is a diagram illustrating an example of a fifth priority ranking table;

FIG. 20 is a diagram illustrating an example of displayed notification information;

FIG. 21 is a diagram illustrating an example of an overall configuration of an information processing system according to an exemplary modification;

FIG. 22 is a diagram illustrating an example of a functional configuration of an information processing device; and

FIG. 23 is a diagram illustrating an example of an overall configuration of an information processing system according to an exemplary modification.

### DETAILED DESCRIPTION

### [1] First Exemplary Embodiment

### [1-1] Overall Configuration

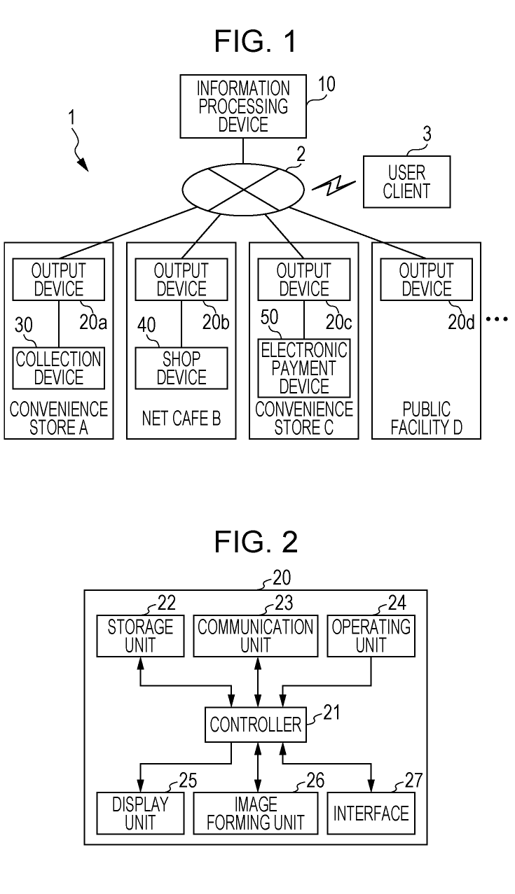

FIG. 1 is a diagram illustrating an example of an overall configuration of an information processing system according to the first exemplary embodiment. FIG. 1 illustrates an information processing system 1 equipped with a network 2, a user client 3, an information processing device 10, output devices 20a, 20b, 20c, and 20d (designated the output devices 20 when not being individually distinguished), a payment receiving device 30, a shop device 40, and an electronic payment device 50. The information processing system 1 provides a user with a fee-based service (hereinafter designated the “pay service”), and in addition, conducts a charge process that charges the user a fee for the pay service (hereinafter designated the “service fee”). In the present exemplary embodiment, the information processing system 1 provides, as the pay service, a service that provides a user with content such as a calendar, local maps, an information magazine, photographs of athletes, and movie tickets.

The network 2 is a system that conducts communication, including the Internet, mobile communication networks, and the like, and mediates the exchange of data between devices connected to the current system, and devices that wirelessly communicate with the current system. The information processing device 10, and the output devices 20 are connected to the network 2. Also, in the example of FIG. 1, the network 2 conducts wireless communication (for example, mobile communication or wireless local area network (LAN) communication) with the user client 3. The user client 3 is a device such as a smartphone, tablet, or personal computer used by a user. Note that although the user client 3 conducts wireless communication with the network 2 in the example of FIG. 1, the user client 3 may also conduct wired communication. The user client 3 is used when the user utilizes the pay service.

The output devices 20 are devices that output content. Specifically, the output devices 20 output content by forming an image expressing content on a medium such as paper. In the present exemplary embodiment, a pay service is provided as a result of a user receiving content output by an output device 20. The output devices 20a, 20b, 20c, and 20d are respectively installed in a convenience store A, a net cafe (a cafe where Internet access is available) B, a convenience store C, and a public facility D. These locations at which the output devices 20 are installed will also be designated “installation locations” hereinafter. Connected to the output devices 20a, 20b, and 20c are a collection device 30, a shop device 40, and an electronic payment device 50, respectively.

The collection device 30 is a device for collecting a service fee (a fee of the pay service), and is sometimes called a coinkit. The collection device 30 according to the present exemplary embodiment allows payment of a service fee by depositing coins, and disallows the depositing of paper currency. The shop device 40 is a device that calculates a usage fee on the basis of factors such as the amount of time a user utilized the net cafe B, and displays the calculated usage fee. The electronic payment device 50 is a device for conducting electronic payment by conducting near field communication (NFC) conforming to the NFC standard with an electronic payment integrated circuit (IC) card equipped with an NFC chip and possessed by a user. The electronic payment device 50 is connected to an electronic payment system (not illustrated), and conducts a process of electronic payment process based on user identification information retrieved from the IC card by NFC communication.

The information processing device 10 is a device that conducts the principal operation in a charge process. For example, the information processing device 10 exchanges data relevant to calculating a service fee with the output devices 20. The information processing device 10 conducts a process of calculating a service fee to charge a user via the exchange, and causing the user to pay the calculated service fee. In addition, in the present exemplary embodiment, the information processing device 10 stores content data expressing content to be provided to the user. For example, when content is requested from a user client 3 or an output device 20, the information processing device 10 transmits content data expressing the requested content to the output device 20.

### [1-2] Hardware Configuration

FIG. 2 is a diagram illustrating an example of a hardware configuration of an output device 20. The output device 20 is a computer equipped with a controller 21, a storage unit 22, a communication unit 23, an operating unit 24, a display unit 25, an image forming unit 26, and an interface 27. The controller 21 is equipped with a central processing unit (CPU), read-only memory (ROM), random access memory (RAM), and a real-time clock, and controls the operation of each device by having the CPU execute a program stored in the ROM or the storage unit 22 while using the RAM as a work area. The real-time clock calculates and reports the current date and time to the CPU.

The storage unit 22 is equipped with a hard disk or the like, and stores information such as data and programs used for control by the controller 21, and image data. A processing program for conducting the above charge process is stored in the storage unit 22. The communication unit 23 is equipped with a communication circuit for conducting communication, and communicates with an external device (the information processing device 10, for example) via the network 2, for example. The display unit 25 is equipped with a liquid crystal display or the like, and displays an image on a display screen. The operating unit 24 is equipped with operating elements such as a touch panel overlaid with a display screen, buttons, or the like, and accepts user operations on these operating elements. The operating unit 24 supplies the controller 21 with operation data according to accepted user operations, and the controller 21 conducts processes according to supplied operation data.

The image forming unit 26 forms an image on a medium such as paper. For example, the image forming unit 26 forms an image onto paper with an electrophotographic system using toner for the four colors of yellow (Y), magenta (M), cyan (C), and black (K). When a facsimile function or an image forming function is executed, for example, the image forming unit 26 outputs image data to a medium by forming an image expressing the image data on a recording medium. The interface 27 is an interface equipped with a port into which is inserted a cable for connecting the collection device 30 and the electronic payment device 50, and exchanges data between these devices.

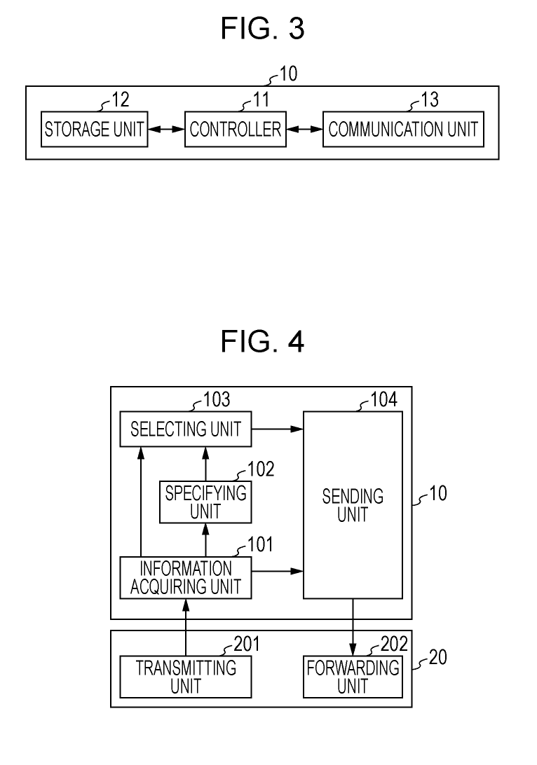

FIG. 3 is a diagram illustrating an example of a hardware configuration of the information processing device 10. The information processing device 10 is a computer equipped with a controller 11, a storage unit 12, and a communication unit 13 having functions similar to the controller 21, the storage unit 22, and the communication unit 23. A processing program for conducting the charge process is stored in the storage unit 12. Image data for content discussed above is also stored in the storage unit 12. The communication unit 13 communicates with an external device (an output device 20, for example) via the network 2.

### [1-3] Functional Configuration

The information processing system 1 conducts the charge process discussed earlier on the basis of the above hardware configurations. The functions discussed hereinafter are realized as a result of the respective controllers of the information processing device 10 and the output device 20 controlling respective units by executing processing programs being stored in the respective storage units.

FIG. 4 is a diagram illustrating an example of a functional configuration of the information processing device 10 and an output device 20. The information processing device 10 is equipped with an information acquiring unit 101, a specifying unit 102, a selecting unit 103, and a sending unit 104, while the output device 20 is equipped with a transmitting unit 201 and a forwarding unit 202.

[1-3-1] Transmitting Unit 201

The transmitting unit 201 is an example of a unit that transmits information indicating details of a pay service that a user uses (hereinafter designated the “service details information”) to the information processing device 10. The transmitting unit 201 is a function realized by the controller 21, the storage unit 22, the communication unit 23, and the operating unit 24, for example. A pay service is started as a result of a user selecting desired content to output from a list of content displayed on the display unit 25 of the output device 20, and determining the number of copies, for example. This operation for starting a pay service, which includes the operation of selecting content and the operation of determining the number of copies, is hereinafter designated the “start operation”.

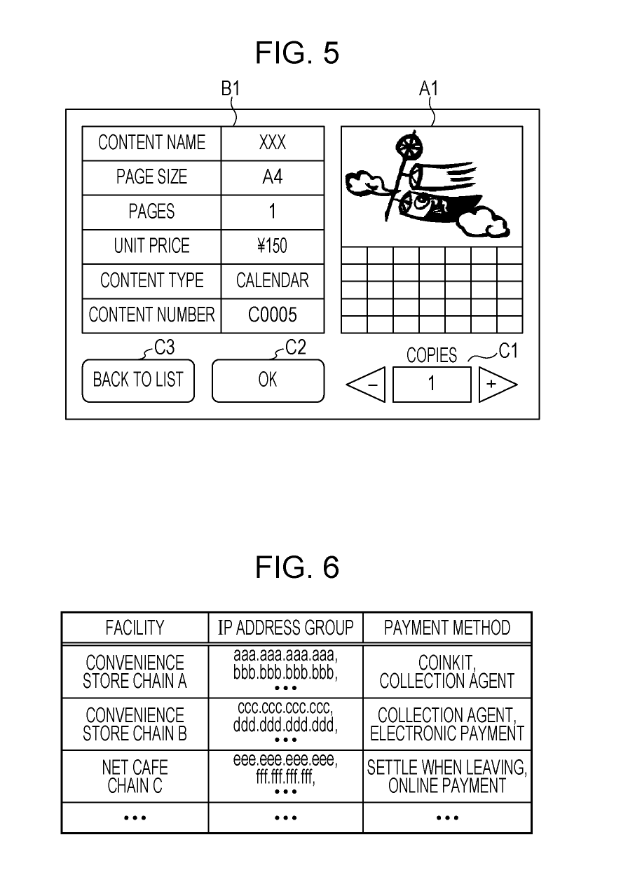

FIG. 5 is a diagram illustrating an example of an image displayed when conducting a start operation. In this example, a content image A1 indicating calendar content, a related image B1 indicating information regarding the content, an operating element image C1 for modifying the number of copies of the content, an operating element image C2 for determining the content and the number of copies, and an operating element image C3 for displaying a list including other content are being displayed on the display unit 25. In the related image B1, the information “XXX”, “A4”, “1”, “¥150”, “Calendar”, and “C0005” are respectively displayed in association with “Content name”, “Page size”, “Pages”, “Unit price”, “Content type”, and “Content number”. “Content number” is a number assigned to individual content, and is a number used to identify respective content. If the user selects the operating element image C2 from the state illustrated in FIG. 5, one copy of the calendar content indicated by the content image A1 is determined for output.

Note that content selection may also be conducted from the user client 3. In this case, the information processing device 10 provides a site that publishes respective content and content-identifying information (the content number illustrated in FIG. 5, for example). The user views the site using the user client 3, and confirms the content number of the desired content to output. As a result of the user inputting the confirmed content number into any output device 20, the content identified by the input content number may be selected.

The controller 21 transmits information containing the content number, unit price, and number of copies determined by the user's start operation as service details information to the information processing device 10 via the communication unit 23. In this way, the transmitting unit 201 conducts the above transmission.

[1-3-2] Information Acquiring Unit 101

The information acquiring unit 101 is an example of a unit that acquires information used to calculate a service fee (hereinafter designated “fee calculation information”) in the case of providing a pay service to a user. The information acquiring unit 101 is a function realized by the controller 11 and the communication unit 13. The communication unit 13 receives, and supplies to the controller 11, service details information transmitted from an output device 20. The controller 11 acquires the service details information supplied from the communication unit 13 as fee calculation information. Since the service details information includes the unit price and the number of copies, a service fee is calculated by multiplying these values (in the case of multiple unit prices, the number of copies is multiplied by the unit price and the result is summed). In this way, the service details information is information used to calculate a service fee, or in other words, fee calculation information. The information acquiring unit 101 supplies fee calculation information acquired in this way (the service details information) to the specifying unit 102 and the selecting unit 103. In addition, the information acquiring unit 101 supplies address information indicating the address of the output device 20 that transmitted the service details information (an IP address, for example) to the sending unit 104.

[1-3-3] Specifying Unit 102

The specifying unit 102 is an example of a unit that, in the case in which a pay service is provided by any of multiple output devices 20, specifies which methods of paying the service fee are available for use on the output device 20 that provided the pay service. In the present exemplary embodiment, six payment methods are used: coinkit, collection agent, nearby collection agent, settle when leaving, electronic payment, and online payment.

Coinkit is a payment method using the collection device 30 (coinkit). A user pays a service fee by inserting enough coins to cover the service fee into the collection device 30. In this case, the service fee is reported to the collection device 30 by communication via the interface 27 of the output device 20. Collection agent is a method of paying a service fee together with paying the price of goods at the counter of a convenience store or the like. In this case, the service fee is output onto a paper sheet, and the service fee is communicated to a store employee by having the user hand over the paper sheet to the store employee. Nearby collection agent is a method of paying a collection agent at another facility in the case in which there is no collection agent at the installation location of the output device 20, but there is a facility (such as a convenience store) acting as a collection agent nearby (for example, in the same building or within 50 m). In other words, if the location where the pay service is provided, or in other words the installation location of the output device 20, is taken to be a first location, nearby collection agent is a method of paying a service fee at a second location different from the first location. Likewise in this case, payment is conducted using a paper sheet onto which the service fee is output.

Settle when leaving is a method of paying a service fee together with paying a usage fee at the counter of a net cafe or the like. In this case, the service fee is communicated to a store employee by having the service fee transmitted from the output device 20 to the shop device 40 and displayed. Electronic payment is a method of paying a fee by holding up an electronic payment IC card to the electronic payment device 50. In this case, the service fee is reported to the electronic payment device 50 by communication via the interface 27 of the output device 20. Online payment is a method of paying a service fee by operating the operating unit 24 of the output device 20 to input information (such as a credit card number) utilized by a site on the Internet providing an online payment service. In this case, the service fee is reported to an external device providing the site by communication via the communication unit 23 of the output device 20.

The specifying unit 102 is a function realized by the controller 11, the storage unit 12, and the communication unit 13. Hereinafter, three methods by which the specifying unit 102 specifies payment methods will be described.

[1-3-3-1] First Specification Method

In the first specification method, the specifying unit 102 specifies payment methods on the basis of information indicating payment methods available for use on the output device 20 that provides the pay service (hereinafter designated “payment method information”), in the case in which the payment method information is included in the service details information. Payment method information refers to character string information expressing a payment method, such as “Coinkit” or “Collection agent”, for example. However, payment method information is not limited thereto, and a predetermined symbol or number corresponding to each payment method may also be used as payment method information. In this case, the output device 20 stores the payment method information, and the transmitting unit 201 discussed earlier includes the payment method information in the service details information and transmits. In the example of FIG. 1, the output device 20a transmits service details information including payment method information that indicates the three payment methods of “Coinkit”, “Collection agent”, and “Online payment”, and the specifying unit 102 specifies these three payment methods, for example.

[1-3-3-2] Second Specification Method

In the second specification method, the specifying unit 102 specifies payment methods on the basis of information acquired by communication with the output device 20 (for example, an IP address whose origin is the output device 20). The specifying unit 102 stores a facility table that associates facilities with the same payment methods available for use, IP address groups being used by output devices 20 installed in those facilities, and the payment methods available for use at those facilities, for example.

FIG. 6 illustrates an example of a facility table. In this example, the facilities “Convenience store chain A”, Convenience store chain B”, and “Convenience store chain C”, the IP address groups “aaa.aaa.aaa.aaa, bbb.bbb.bbb.bbb, . . . ”, “ccc.ccc.ccc.ccc, ddd.ddd.ddd.ddd, . . . ” and “eee.eee.eee.eee, fff.fff.fff.fff, . . . ”, and the payment methods “Coinkit, Collection agent”, “Collection agent, Electronic payment”, and “Settle when leaving, Online payment” are respectively associated with each other. For each respective facility illustrated in FIG. 6, the same payment methods available for use are shared in common.

Note that in the example of FIG. 6, although all facilities in the “Convenience store chain A” share the same payment methods in common, for example, the payment methods may also differ among these facilities. For example, in one case given facilities in the “Convenience store chain A” may only have “Collection agent” available for use, whereas the remaining facilities have “Coinkit” and “Collection agent” available for use. In this case, it is sufficient to associate “Collection agent” with the IP address group of the facilities having only “Collection agent” available for use, and associate “Coinkit” and “Collection agent” with the IP address group of the facilities having “Coinkit” and “Collection agent” available for use.

In the case in which the specifying unit 102 receives service details information from an output device 20, and the originating IP address is included in an IP address group in the facility table, the payment methods associated with that IP address are specified as the payment methods available for use at the output device 20 that transmitted the service details information. In the example in FIG. 1, in the case in which the originating IP address of service details information transmitted from the output device 20b is fff.fff.fff.fff, for example, the specifying unit 102 specifies “Settle when leaving” and “Online payment” associated with this IP address in the facility table as the payment methods.

[1-3-3-3] Third Specification Method

In the third specification method, the specifying unit 102 specifies payment methods on the basis of information indicating the installation location of an output device 20 (hereinafter designated “installation location information”). In this case, the output device 20 stores latitude and longitude information indicating the position of the device itself as the installation location information, for example. When service details information is supplied from the information acquiring unit 101, the specifying unit 102 acquires installation location information from the output device 20 by using Simple Network Management Protocol (SNMP) or the like. The specifying unit 102 stores a nearby collection agent table that associates facilities capable of acting as a nearby collection agent, the locations thereof, and data expressing routes to those facilities (hereinafter designated “route data”), for example.

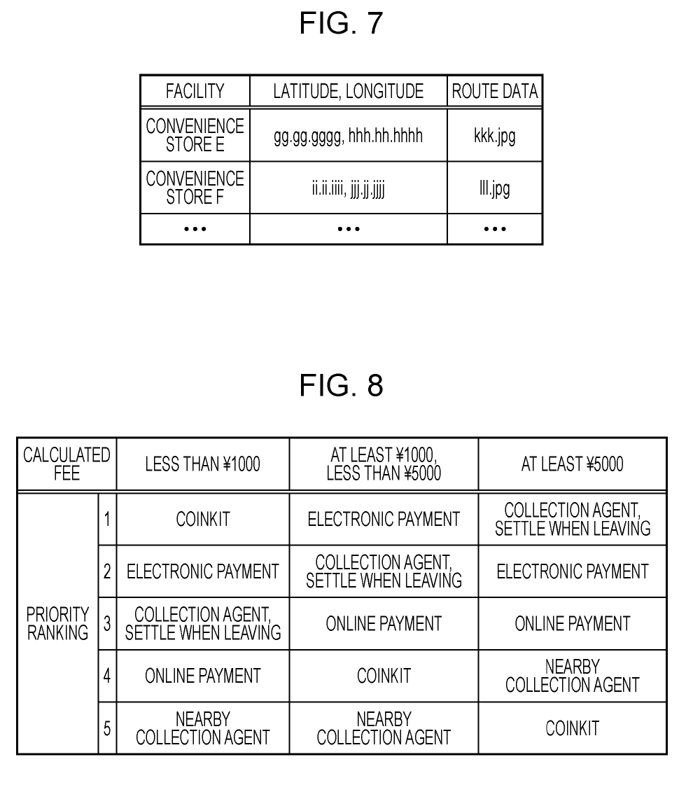

FIG. 7 is a diagram illustrating an example of a nearby collection agent table. In this example, the latitudes and longitudes “gg.gg.gggg, hhh.hh.hhhh” and “ii.ii.iiii, jjj.jj.jjjj” and the route data “kkk.jpg” and “lll.jpg” are respectively associated with the facilities “Convenience store E” and “Convenience store F”. In the case in which the nearby collection agent table includes a latitude and longitude within a designated distance (50 m, for example) from a latitude and longitude indicated by acquired installation location information, the specifying unit 102 specifies “Nearby collection agent” as the payment method.

The specifying unit 102, upon specifying payment methods using the first, second, and third specification methods discussed above, reports the specified payment methods to the selecting unit 103. Also, in the case of specifying a nearby collection agent, the specifying unit 102 supplies the selecting unit 103 with route data associated with the latitude and longitude included in the nearby collection agent table for that specification.

[1-3-4] Selecting Unit 103

The selecting unit 103 is an example of a unit that selects at least one payment method from among multiple payment methods in the case in which such multiple payment methods exist for a service fee calculated on the basis of fee calculation information acquired by the information acquiring unit 101 (hereinafter designated the “calculated fee”). The selecting unit 103 is a function realized by the controller 11 and the storage unit 12. In the present exemplary embodiment, in the case in which the specifying unit 102 has specified multiple payment methods, the selecting unit 103 selects the multiple payment methods as the multiple payment methods for the calculated fee. More specifically, the selecting unit 103 selects payment methods on the basis of information that may influence the selection of a payment method (hereinafter designated “influence information”).

The influence information is, for example, the service fee. For example, payment by coinkit (the collection device 30) becomes increasingly inconvenient as the service fee increases, because of the increase in the number of coins to have ready as well as the burden of depositing those coins. Also, with electronic payment, payment itself may become unavailable if the service fee exceeds the amount of payable funds being stored in the IC card, and the possibility of this situation rises as the service fee increases. On the other hand, although online payment is more burdensome compared to other payment methods, that burden does not change even if the service fee changes. For this reason, a user who wants to pay by coinkit in the case of a ¥500 service fee may also conceivably want to pay by online payment if the service fee is ¥5000, for example.

In addition, the time period when the pay service is provided (hereinafter designated the “provision period”) may also be used as influence information. For example, a user who does not want to pay a nearby collection agent while he or she is busy on the way to work may also conceivably accept paying a nearby collection agent when he or she has more time, such as on a weekend or holiday. The question of wanting to pay a collection agent or not may also change depending on whether or not the time period is during a time when the counter becomes busy. In this way, the service fee and the provision period are both information that may influence the selection of a payment method. In the present exemplary embodiment, methods of selecting a payment method using the service fee and the provision period (respectively designated the “first selection method” and the “second selection method”) will be described.

[1-3-4-1] First Selection Method

The selecting unit 103 selects a payment method using the calculated fee discussed earlier (in other words, a service fee calculated on the basis of fee calculation information acquired by the information acquiring unit 101) as influence information. The selecting unit 103 stores a first priority ranking table that associates calculated fees with a priority ranking of payment methods.

FIG. 8 is a diagram illustrating an example of a first priority ranking table. In this example, in the case in which the calculated fee is “less than ¥1000”, the payment methods “Coinkit”, “Electronic payment”, “Collection agent, Settle when leaving”, “Online payment”, and “Nearby collection agent” are given an associated priority ranking in the above order (coinkit 1st, nearby collection agent 5th). Meanwhile, in the case in which the calculated fee is “at least ¥1000, less than ¥5000”, a priority ranking in the order of “Electronic payment”, “Collection agent, Settle when leaving”, “Online payment”, “Coinkit”, and “Nearby collection agent” is associated, and in the case in which the calculated fee is “at least ¥5000”, a priority ranking in the order of “Collection agent, Settle when leaving”, “Electronic payment”, “Online payment”, “Nearby collection agent”, and “Coinkit” is associated with the payment methods, respectively.

The selecting unit 103 calculates a service fee using fee calculation information supplied from the information acquiring unit 101. Also, in the case in which multiple payment methods are reported from the specifying unit 102, the selecting unit 103 selects a payment method which is a reported payment method and which has the highest priority ranking from among the payment methods associated with the calculated service fee, or in other words the calculated fee, in the first priority ranking table.

For example, in the case in which a service fee of ¥500 is calculated, and the payment methods “Coinkit” and “Collection agent” are reported from the specifying unit 102, the selecting unit 103 selects “Coinkit”, since among the payment methods associated with a calculated fee of “less than ¥1000”, the priority ranking of “Coinkit” (1st) is higher than the priority ranking of “Collection agent” (3rd). Also, in the case in which a service fee of ¥2000 is calculated, and the payment methods “Coinkit”, “Electronic payment”, and “Collection agent” are reported from the specifying unit 102, the selecting unit 103 selects “Electronic payment”, since among the payment methods associated with a calculated fee of “at least ¥1000, less than ¥5000”, the priority ranking of “Electronic payment” (1st) is higher than the other two payment methods, (collection agent 3rd, coinkit 4th).

[1-3-4-2] Second Selection Method

The selecting unit 103 selects a payment method using the above provision period (the time period when the pay service is provided) as influence information. The selecting unit 103 stores a second priority ranking table that associates provision periods with a priority ranking of payment methods.

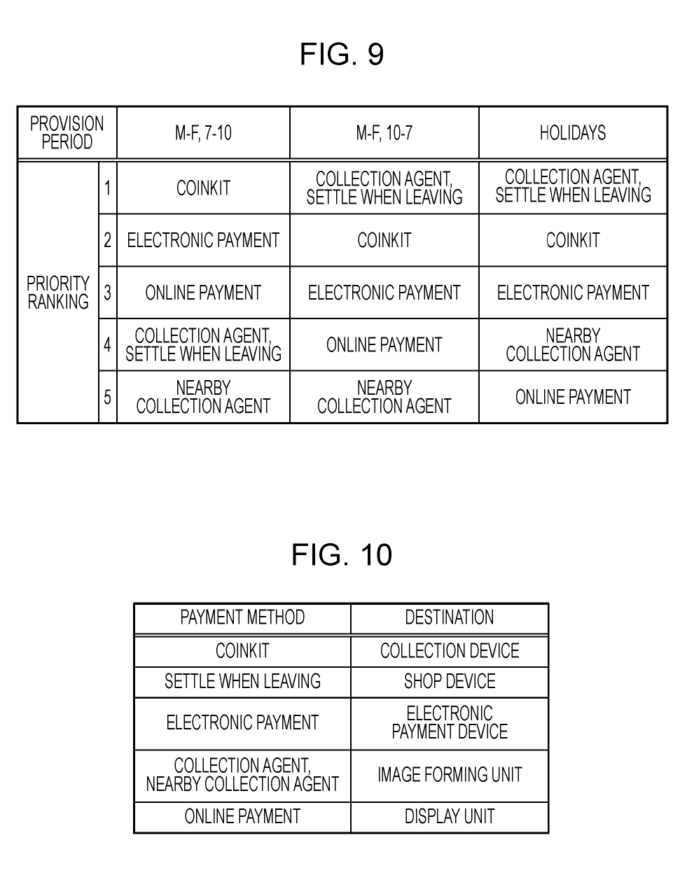

FIG. 9 is a diagram illustrating an example of a second priority ranking table. In this example, in the case in which the provision period is “M-F, 7-10”, the payment methods “Coinkit”, “Electronic payment”, “Online payment”, “Collection agent, Settle when leaving”, and “Nearby collection agent” are associated with a priority ranking in the above order (coinkit 1st, nearby collection agent 5th).

Meanwhile, in the case in which the provision period is “M-F, 10-7”, a priority ranking in the order of “Collection agent, Settle when leaving”, “Coinkit”, “Electronic payment”, “Online payment”, and “Nearby collection agent” is associated, and in the case in which the calculated fee is “Holidays”, a priority ranking in the order of “Collection agent, Settle when leaving”, “Coinkit”, “Electronic payment”, “Nearby collection agent”, and “Online payment” is associated with the payment methods, respectively. The selecting unit 103 treats the time at which fee calculation information is supplied from the information acquiring unit 101 or the time at which payment methods are reported from the specifying unit 102 as the time at which the pay service is provided, and selects a payment method on the basis of the priority ranking of payment methods associated with a provision period that includes that time.

For example, in the case in which, during a provision period of M-F 7-10, the payment methods “Coinkit” and “Collection agent” are reported from the specifying unit 102, the selecting unit 103 selects “Coinkit”, since among the payment methods associated with that provision period, the priority ranking of “Coinkit” (1st) is higher than the priority ranking of “Collection agent” (4th). Also, in the case in which, during a provision period on a holiday, the payment methods “Nearby collection agent” and “Online payment” are reported from the specifying unit 102, the selecting unit 103 selects “Nearby collection agent”, since among the payment methods associated with that provision period, the priority ranking of “Nearby collection agent” (4th) is higher than the priority ranking of “Online payment” (5th).

The selecting unit 103, upon selecting a payment method using the first and second specification methods discussed above, reports the selected payment method to the sending unit 104. In addition, in the case in which nearby collection agent is selected, the specifying unit 102 additionally supplies the sending unit 104 with route data supplied from the specifying unit 102.

[1-3-5] Sending Unit 104

The sending unit 104 is an example of a unit that sends information (hereinafter designated “charge information”) for charging the calculated fee discussed earlier (a calculated service fee) to a destination depending on the payment method selected by the selecting unit 103. The content of the charge information differs by payment method. For example, if coinkit or electronic payment, information indicating a calculated fee (hereinafter designated “fee information”) is included in the charge information. Meanwhile, if collection agent, page description language (PDL) data expressing printed matter displaying a calculated fee (service fee) to pass to an employee at the counter is included in the charge information. Meanwhile, if settle when leaving, information for specifying the user is included in the charge information in addition to fee information. Information for specifying the user may be the seat number of a seat utilized by the user at a net cafe, for example. In this case, an operation of inputting a seat number is included in the start operation (the operation for starting the pay service).

Also, if online payment, the Uniform Resource Locator (URL) of a site for online payment available for use is included in the charge information in addition to fee information. Also, if nearby collection agent, the PDL data discussed for collection agent, as well as the report of the payment method and supplied route data is included in the charge information. This route data is data indicating a route to the second location discussed earlier (in the case of treating the installation location of the output device 20 as a first location, a location that differs therefrom). In other words, in the case in which nearby collection agent, or in other words a method of paying a service fee at a second location, is selected by the selecting unit 103, the sending unit 104 sends to the output device 20 charge information that includes route data indicating a route to that second location.

The sending unit 104 is a function realized by the controller 11, the storage unit 12, and the communication unit 13. The storage unit 12 stores a destination table that associates payment methods and destinations.

FIG. 10 is a diagram illustrating an example of a destination table. In this example, the destinations “Collection device”, “Shop device”, “Electronic payment device”, “Image forming unit”, and “Display unit” are associated with the payment methods “Coinkit”, “Settle when leaving”, “Electronic payment”, “Collection agent, Nearby collection agent”, and “Online payment”, respectively.

The controller 11 generates charge information according to the payment method reported from the selecting unit 103, and transmits a forwarding request that requests forwarding the generated charge information to the destination associated with that payment method in the destination table, while also transmitting the generated charge information via the communication unit 13 to an address indicated by address information supplied from the information acquiring unit 101. This address is the address of the output device 20 that transmitted the service details information, or in other words, the output device 20 at which the user utilized the pay service. At the output device 20, the transmitted charge information is forwarded by the forwarding unit 202 discussed later to the requested destination, or in other words one of the collection device 30, the shop device 40, the electronic payment device 50, the image forming unit 26, and the display unit 25, and reaches the destination. In this way, the sending unit 104 sends charge information to a destination.

[1-3-6] Transmitting Content Data

The controller 11 retrieves content data to provide to the user on the basis of the details of the service indicated by service details information acquired by the information acquiring unit 101, and transmits the retrieved content data together with charge information to an address indicated by address information (that is, an output device 20) via the communication unit 13. Note that the pay service may involve compositing content expressed by content data stored by the information processing device 10 with a photograph provided by the user, for example, and outputs the composited result as the content to provide. In this case, the controller 11 generates content to provide from content data being stored in the storage unit 12 and image data provided from the user, and transmits content data expressing the generated content together with charge information.

[1-3-7] Forwarding Unit 202

The forwarding unit 202 is an example of a unit that forwards charge information sent towards a destination from the information processing device 10 to that destination. The forwarding unit 202 is a function realized by the controller 21, the communication unit 23, the display unit 25, the image forming unit 26, and the interface 27. When charge information and a forwarding request is supplied via the communication unit 23, the controller 21 transmits the charge information to the destination requested by the forwarding request. If the destination is a collection device, the controller 21 transmits the charge information to the collection device 30 via the interface 27, whereas if the destination is an image forming unit and a display unit, the controller 21 respectively supplies the charge information to the image forming unit 26 and the display unit 25. In this way, the forwarding unit 202 forwards charge information.

[1-3-8] Outputting Content

The controller 21 supplies content data transmitted from the information processing device 10 to the image forming unit 26, for example, and causes an image of the content expressed by that content data to be formed on a medium such as paper. In this way, content output to a medium is provided to the user.

### [1-4] Operation

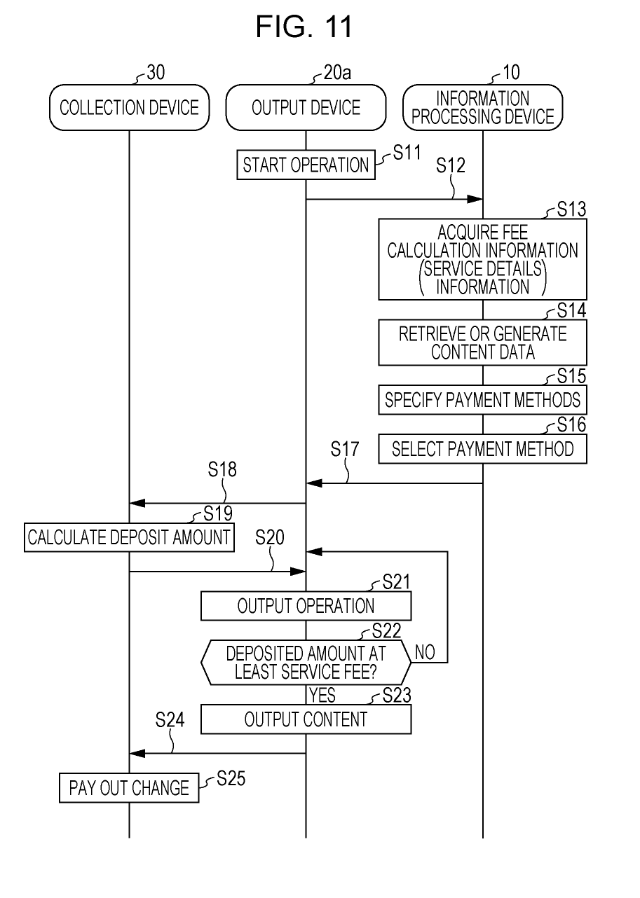

The output device 20 conducts the charge process discussed above (a process of charging the user with a service fee) on the basis of the above configuration. The operation conducted by each device in the charge process will now be respectively described for each payment method with reference to FIGS. 11 to 15.

FIG. 11 is a sequence diagram illustrating exemplary operation of respective devices in a charge process for the case in which coinkit is selected as the payment method. In this example, the output device 20a connected to the coinkit (the collection device 30) in FIG. 1 operates. The charge process is started when triggered by the user conducting a start operation (an operation for starting a pay service).

First, when the output device 20a receives a user's start operation (step S11), service details information indicating details of the pay service to be started is transmitted to the information processing device 10 (step S12). Steps S11 and S12 are operations conducted by the transmitting unit 201. The information processing device 10 acquires the service details information received in step S12 as fee calculation information (step S13). Step S13 is an operation conducted by the information acquiring unit 101. Next, the information processing device 10 retrieves or generates content data on the basis of the details indicated by the service details information (step S14).

Subsequently, the information processing device 10 specifies one or more payment methods available for use on the output device 20a with the first, second, and third specification methods discussed earlier (step S15). Step S15 is an operation conducted by the specifying unit 102. In the case in which there are multiple specified payment methods, the information processing device 10 selects one payment method therefrom (step S16). In this example, the information processing device 10 selects coinkit using the collection device 30 as the payment method. Step S16 is an operation conducted by the selecting unit 103. Subsequently, the information processing device 10 sends charge information according to the selected payment method to a destination (in the example in FIG. 11, the collection device 30) according to the selected payment method (step S17). In step S17, the information processing device 10 sends charge information while also transmitting the content data retrieved or generated in step S14 to the output device 20a.

The output device 20a forwards the charge information received in step S17 to the destination, that is, the collection device 30 (step S18). Step S18 is an operation conducted by the forwarding unit 202. The collection device 30 calculates the amount of coins to be deposited by the user (hereinafter designated the “deposit amount”) (step S19), and reports the calculated deposit amount to the output device 20a (step S20). When the output device 20a receives a user operation for outputting content (hereinafter designated the “output operation”; for example, an operation of pressing a “Start” operating element provided in the operating unit 24) (step S21), the output device 20a determines whether or not an amount equal to or greater than a calculated fee indicated by fee information included in the charge information (in other words, the service fee) has been deposited (step S22).

In the case of a negative determination (NO) in step S22, the output device 20 returns to step S20 and waits for a new deposit amount to be reported. In the case of determining that an amount equal to or greater than the service fee was deposited in step S22 (YES), the output device 20a outputs content on the basis of the content data received in step S17 (step S23). In this way, in the case in which the payment method is coinkit, the pay service is provided by advance payment. Nest, the output device 20a reports to the collection device 30 that content was output (step S24), and the collection device 30 pays out change equal to the amount obtained by subtracting the calculated fee indicated by the fee information from the deposit amount (step S25). The charge process ends at this point.

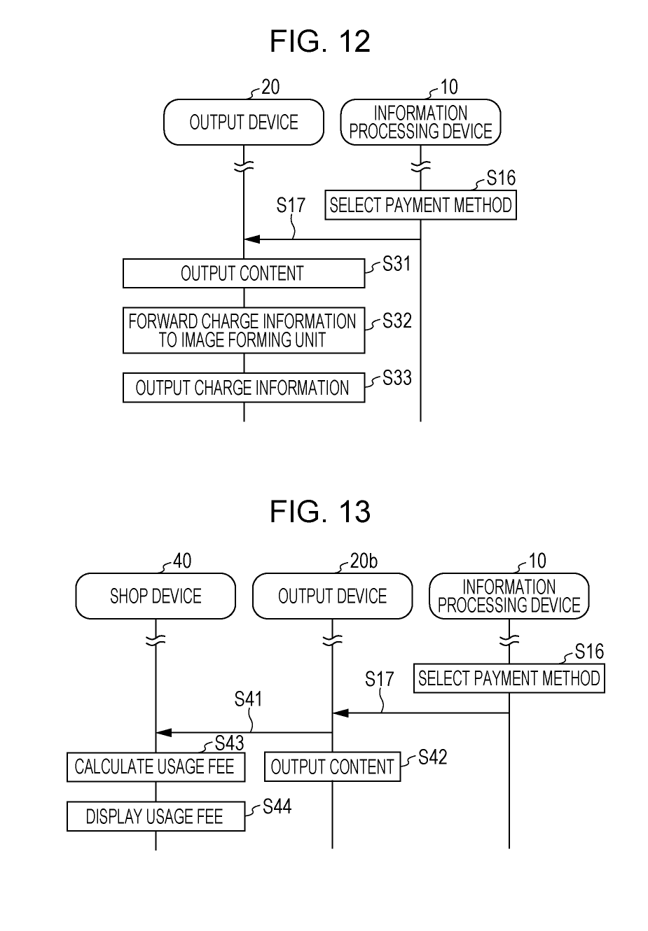

FIG. 12 is a sequence diagram illustrating exemplary operation of respective devices in a charge process for the case in which collection agent or nearby collection agent is selected as the payment method. In this case, first, the operation up to step S17 illustrated in FIG. 11 is conducted. Next, the output device 20 outputs content on the basis of the content data received in step S17 (step S31). Subsequently, the output device 20 forwards the charge information received in step S17 (more specifically, PDL data included in the charge information) to the image forming unit 26 provided in the device itself (step S32). Step S32 is an operation conducted by the forwarding unit 202. Note that steps S31 and S32 may be conducted in reverse order, or together. Subsequently, the output device 20 outputs charge information (PDL data) to a medium such as paper by operation of the image forming unit 26 (step S33). A calculated fee, or in other words a service fee, is displayed on the medium output in this way. The charge process ends at this point. In this case, payment is completed as a result of the user handing over the output medium to an employee at the counter of a convenience store or the like, and paying the service fee displayed on the medium. In this way, in the case in which the payment method is collection agent or nearby collection agent, the pay service is provided by deferred payment.

FIG. 13 is a sequence diagram illustrating exemplary operation of respective devices in a charge process for the case in which settle when leaving is selected as the payment method. In this example, the output device 20b connected to the shop device 40 in FIG. 1 operates. First, the operation up to step S17 illustrated in FIG. 11 is conducted. Next, the output device 20b forwards the charge information received in step S17 to the collection device 40 (step S41). Step S41 is an operation conducted by the forwarding unit 202. Subsequently, the output device 20b outputs content on the basis of the content data received in step S17 (step S42).

The shop device 40 calculates a usage fee on the basis of the charge information transmitted in step S41 (step S43), and displays the calculated usage fee (step S44). Besides the service fee, this usage fee includes a fee for utilizing the net cafe B. The charge process ends at this point. In this case, payment of the service fee is also completed as a result of the user paying an employee the usage fee displayed by the shop device 40. In this way, in the case in which the payment method is settle when leaving, the pay service is provided by deferred payment.

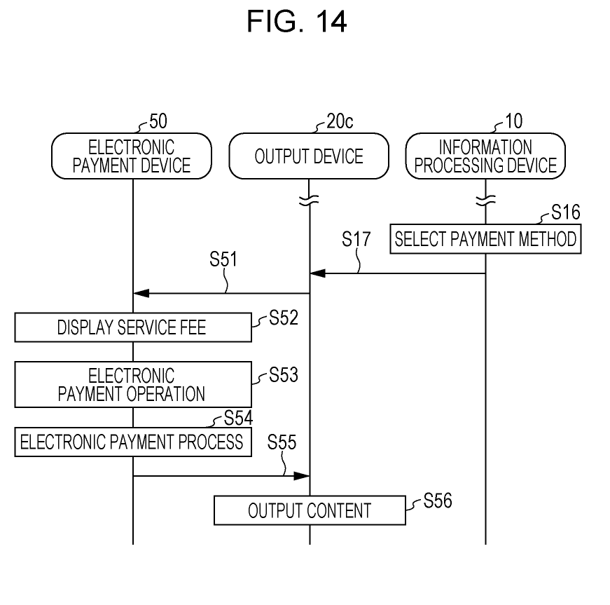

FIG. 14 is a sequence diagram illustrating exemplary operation of respective devices in a charge process for the case in which electronic payment is selected as the payment method. In this example, the output device 20c connected to the electronic payment device 50 in FIG. 1 operates. First, the operation up to step S17 illustrated in FIG. 11 is conducted. Next, the output device 20c forwards the charge information received in step S17 to the electronic payment device 50 (step S51). Step S51 is an operation conducted by the forwarding unit 202. The electronic payment device 50 displays a service fee indicated by the received charge information (step S52).

If the user performs an operation of, for example, holding up an IC card to the electronic payment device 50 as an operation for conducting electronic payment (an electronic payment operation) (step S53), the electronic payment device 50 conducts an electronic payment process on the basis of information retrieved from the IC card (step S54). Subsequently, if the electronic payment device 50 reports to the output device 20c that electronic payment has been conducted (step S55), the output device 20c outputs content on the basis of the content data received in step S17 (step S56). The charge process ends at this point. In this way, in the case in which the payment method is electronic payment, the pay service is provided by advance payment.

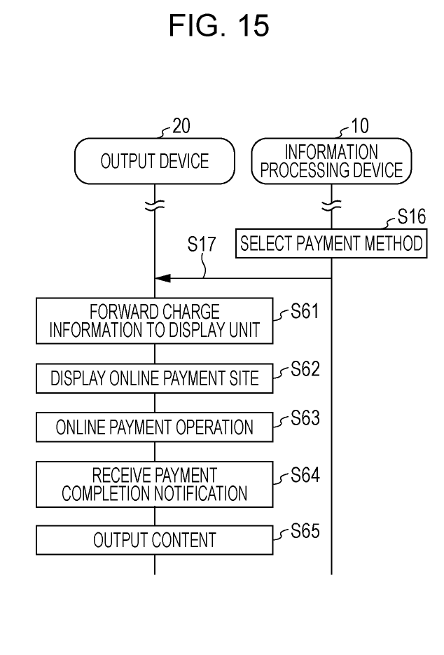

FIG. 15 is a sequence diagram illustrating exemplary operation of respective devices in a charge process for the case in which online payment is selected as the payment method. In this case, first, the operation up to step S17 illustrated in FIG. 11 is conducted. Next, the output device 20 forwards the charge information received in step S17 to the display unit 25 provided in the device itself (step S61). Step S61 is an operation conducted by the forwarding unit 202. Subsequently, the output device 20 displays an online payment site (a site for online payment) using a URL indicated by the charge information (step S62). Subsequently, if the output device 20 receives an operation for purpose of online payment by the user (step S63), and receives a report from the online payment site indicating that payment has completed (step S64), the output device 20 outputs content on the basis of the content data received in step S17 (step S65). The charge process ends at this point. In this way, in the case in which the payment method is online payment, the pay service is provided by advance payment.

### [1-5] Effects According to First Exemplary Embodiment

In the present exemplary embodiment, in the case in which a fee incurred when utilizing a pay service (in other words, a service fee) may be paid by multiple methods, an information processing device 10 selects a payment method and sends charge information, thereby enabling a user to pay by the selected payment method. For this reason, even if there are multiple payment methods, the user is relieved of the burden of investigating which payment method to select. Also, if charge information is not sent to a destination according to a selected payment method as in the present exemplary embodiment, the user is responsible for conducting an operation of selecting a method to use for actual payment from among the multiple payment methods. This is because if the operation is not conducted, a deferred payment charge process may be conducted and the content may be output first in a case in which the user wants to pay by a payment method of advance payment. Conversely, in the present exemplary embodiment, the user is not responsible for conducting such an operation of selecting a payment method. In this way, according to the present exemplary embodiment, payment by the user takes less time and effort when there are multiple payment methods compared to the case in which the selection of a payment method and the sending of charge information are not conducted.

Also, in the present exemplary embodiment, the service fee is used as influence information, or in other words, information that may influence the selection of a payment method. By selecting a payment method while taking into account such influence, as discussed earlier in the explanation of FIG. 8, for example, payment of a fee is conducted by a more desirable method compared to the case of not using the service fee as influence information.

Also, in the present exemplary embodiment, the provision period of a pay service is used as influence information. As discussed earlier, the amount of time taken for payment may vary depending on the provision period. By selecting a payment method while taking into account such variance, as discussed earlier in the explanation of FIG. 9, for example, payment of a fee is conducted by a more desirable method compared to the case of not using the provision period of the pay service as influence information.

In this way, according to the present exemplary embodiment, by selecting a payment method on the basis of influence information as in the examples of FIGS. 8 and 9, payment of a fee is conducted by a more desirable method compared to the case of selecting a payment method irrespectively of influence information.

Also, in the present exemplary embodiment, payment methods available for use at each output device 20 are specified. Consequently, a payment method is selected even in the case in which the payment methods available for use at an output device that provided a service are not ascertained in advance.

Also, in the present exemplary embodiment, in the case of selecting nearby collection agent as the payment method, route data is sent as charge information, and that route data is output to a medium at the output device 20. Consequently, compared to the case of not sending route data, the user is able to more easily move to the second location (that is, the location at which to pay a nearby collection agent) without getting lost, and more easily pay a fee at the second location.

### [2] Second Exemplary Embodiment

Regarding the second exemplary embodiment of the present invention, hereinafter the points that differ from the first exemplary embodiment will mostly be described. In the first exemplary embodiment, the service fee and the provision period are used as influence information, but in the second exemplary embodiment, user attributes, the pay service type, and the distance between the first location and the second location for nearby collection agent, or in other words the distance that the user travels in order to pay (hereinafter designated the “travel distance”) are used as influence information. Hereinafter, methods of selecting a payment method using user attributes, the pay service type, and travel distance (respectively designated the “third selection method”, “fourth selection method”, and “fifth selection method”) will be described.

[2-1] Functional Configuration

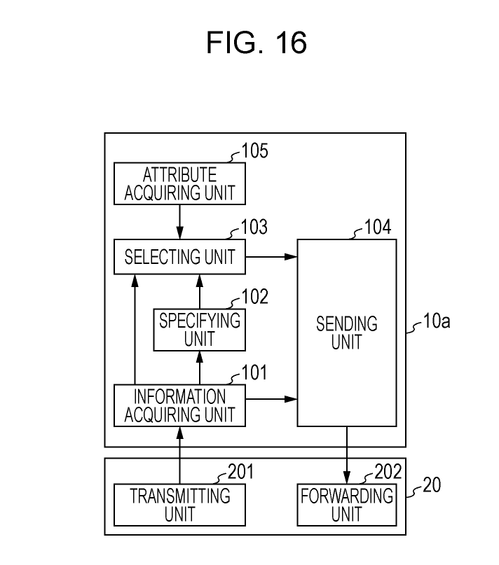

FIG. 16 is a diagram illustrating an example of a functional configuration of an information processing device and an output device according to the second exemplary embodiment. In this example, an information processing device 10a equipped with an attribute acquiring unit 105 is illustrated in addition to the respective units illustrated in FIG. 4.

The attribute acquiring unit 105 is an example of a unit that acquires attribute information indicating user attributes. The attribute acquiring unit 105 is a function realized by the controller 11, the storage unit 12, and the communication unit 13. In the present exemplary embodiment, a user who utilizes a pay service conducts user registration, and the registration details are stored in the storage unit 12 of the information processing device 10a. The user utilizes the pay service by logging in using a registered user ID or the like.

The registration details include information indicating whether or not the user possesses an IC card usable with the electronic payment device 50 (hereinafter designated “electronic payment availability information”), and information indicating whether or not the user is registered with an online payment site available for use with the pay service (hereinafter designated “registration flag information”). The controller 11 acquires, as attribute information, the electronic payment availability information and registration flag information supplied via the communication unit 13 as a result of the user conducting user registration. The controller 11 stores the acquired attribute information in the storage unit 12. In this way, the attribute acquiring unit 105 acquires attribute information.

Note that the attribute acquiring unit 105 may also acquire attribute information by a method other than the above. For example, in the case in which the user utilizes a pay service and pays a service fee by electronic payment, the attribute acquiring unit 105 acquires attribute information by storing electronic payment availability information indicating that electronic payment is possible in association with the user ID of that user, and in the case in which the user is registered with an online payment site, the attribute acquiring unit 105 acquires attribute information by storing registration flag information indicating that a registered account exists at the online payment site in association with the user ID of that user. The attribute acquiring unit 105 supplies the selecting unit 103 with attribute information acquired in this way.

[2-2-1] Third Selection Method

The selecting unit 103 selects a payment method using an attribute indicated by attribute information acquired by the attribute acquiring unit 105 as influence information. The selecting unit 103 stores a third priority ranking table that associates attribute information with a priority ranking of payment methods.

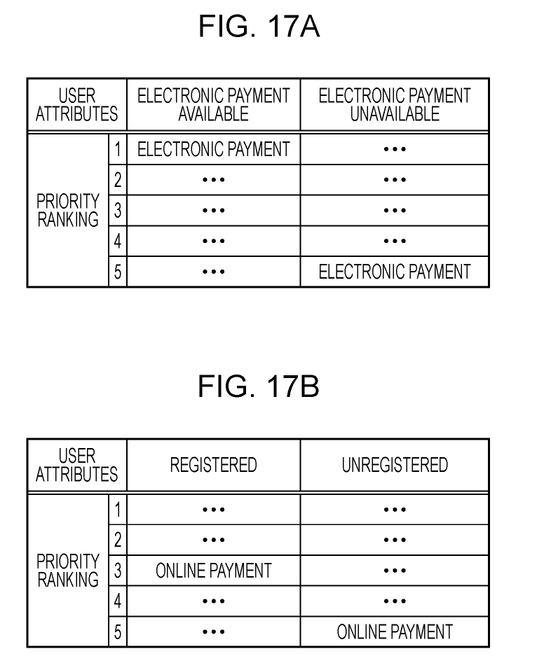

FIG. 17 is a diagram illustrating an example of a third priority ranking table. In FIG. 17A, the priority ranking of “Electronic payment” is 1st in the case in which the user attribute is “Electronic payment available”, while the priority ranking of “Electronic payment” is 5th in the case in which the user attribute is “Electronic payment unavailable”. In FIG. 17B, the priority ranking of “Online payment” is 3rd in the case in which the user attribute is “Registered”, while the priority ranking of “Online payment” is 5th in the case in which the user attribute is “Unregistered”. The selecting unit 103 uses the third priority ranking table to select a payment method as discussed in the first exemplary embodiment.

[2-2-2] Effects According to Third Selection Method

In the third selection method, user attributes are used as influence information, or in other words, information that may influence the selection of a payment method. For example, for a user possessing an IC card and capable of electronic payment, selecting electronic payment as the payment method may be desirable, whereas for a user not possessing an IC card, selecting electronic payment as the payment method may be undesirable. If a table like that illustrated in FIG. 17A is used, for example, a payment method desirable to the former user (that is, electronic payment method) is more readily selected compared to others, while a payment method that is undesirable to the latter user (likewise electronic payment) is less readily selected compared to others. For this reason, payment of a fee is conducted by a more desirable method compared to the case of not using user attributes as influence information.

Also, for a user who is already registered with an online payment site, no registration burden is imposed even if online payment is selected as the payment method, whereas for a user who is not registered, a registration burden is imposed if online payment is selected as the payment method. In other words, online payment is a less burdensome payment method to the former user compared to the latter user, and may be said to be a more desirable payment method. If a table like that illustrated in FIG. 17B is used, for example, a payment method desirable to the former user (that is, online payment method) is more readily selected compared to the latter user, while a payment method that is undesirable to the latter user (likewise online payment) is less readily selected compared to the former user. For this reason, payment of a fee is conducted by a more desirable method compared to the case of not using user attributes as influence information.

[2-3-1] Fourth Selection Method

The selecting unit 103 selects a payment method using the type of pay service provided to the user as influence information. The selecting unit 103 stores a fourth priority ranking table that associates pay service types with a priority ranking of payment methods.

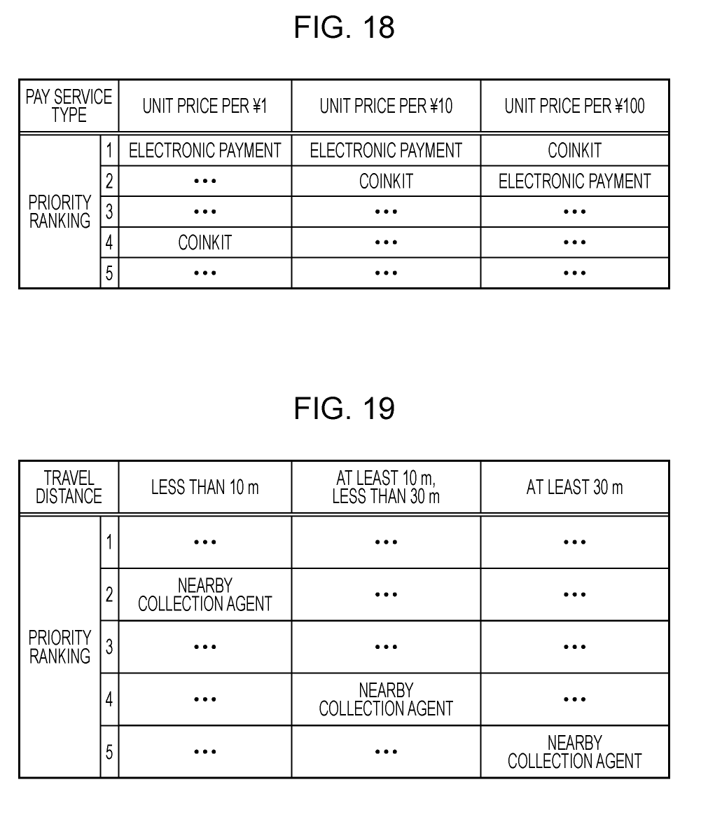

FIG. 18 is a diagram illustrating an example of a fourth priority ranking table. In this example, in the case in which the pay service type is “Unit price per ¥1”, the priority ranking of “Electronic payment” and “Coinkit” is 1st and 4th, respectively. Also, in the case in which the pay service type is “Unit price per ¥10”, the priority ranking of “Electronic payment” and “Coinkit” is 1st and 2nd, respectively, and in the case in which the pay service type is “Unit price per ¥100”, the priority ranking of “Electronic payment” and “Coinkit” is 2nd and 1st, respectively. The selecting unit 103 uses the fourth priority ranking table to select a payment method as discussed in the first exemplary embodiment.

[2-3-2] Effects According to Fourth Selection Method

In the fourth selection method, the pay service type is used as influence information. For example, in the case in which the unit price is in units of ¥100, paying with coins using coinkit is not inconvenient, but as the unit price becomes more exact in units of ¥10 or in units of ¥1, paying with coins becomes inconvenient (specifically, the number of coins to have ready as well as the burden of depositing those coins increases). On the other hand, with electronic payment, the burden of paying does not change even if the unit price becomes more exact. In other words, coinkit is a payment method that is less desirable as the unit price becomes more exact, while conversely, electronic payment is a payment method that is more desirable as the unit price becomes more exact. In other words, by using a table like that illustrated in FIG. 18, for example, coinkit is less readily selected in cases in which coinkit is a less desirable payment method, while electronic payment is more readily selected in cases in which electronic payment is a more desirable payment method. Accordingly, payment of a fee is conducted by a more desirable method compared to the case of not using the pay service type as influence information.

[2-4-1] Fifth Selection Method

The selecting unit 103 selects a payment method using the above travel distance, or in other words the distance between the first location and the second location, as influence information. The selecting unit 103 stores a fifth priority ranking table that associates travel distances with a priority ranking of payment methods.

FIG. 19 is a diagram illustrating an example of a fifth priority ranking table. In this example, in the case in which the travel distance is “less than 10 m”, the priority ranking of “Nearby collection agent” is 2nd. Also, in the cases in which the travel distance is “at least 10 m, less than 30 m” and “at least 30 m”, the priority ranking of “Nearby collection agent” is 4th and 5th, respectively. The selecting unit 103 uses the fifth priority ranking table to select a payment method as discussed in the first exemplary embodiment.

[2-4-2] Effects According to Fifth Selection Method

In the fifth selection method, travel distance is used as influence information. If the travel distance, or in other words the distance that the user travels in order to pay, becomes shorter, the user burden decreases, and thus nearby collection agent becomes a more desirable payment method. In other words, by using a table like that illustrated in FIG. 19, for example, nearby collection agent is more readily selected in cases in which nearby collection agent is a more desirable payment method. Consequently, payment of a fee is conducted by a more desirable method compared to the case of not using the travel distance as influence information.

### [3] Exemplary Modifications

Each exemplary embodiment discussed above is merely an example of respectively carrying out the present invention, and may also be modified as follows. Also, each exemplary embodiment discussed above and each exemplary modification indicated below may also be carried out in combination as appropriate.

[3-1] Determining Multiple Payment Methods

In each of the foregoing exemplary embodiments, one payment method is selected, but multiple payment methods may also be selected. In this case, the selecting unit 103 selects multiple payment methods on the basis of influence information. For example, in the case of using the first selection method, the selecting unit 103 selects, from among multiple payment methods reported from the specifying unit 102, two payment methods associated with the calculated service fee and also having the highest priority ranking in the first priority ranking table, for example. Note that the selecting unit 103 may also select three or more payment methods.

The sending unit 104 sends information for notifying the user to select one of the multiple payment methods selected by the selecting unit 103 (hereinafter designated “notification information”). The output device 20 displays notification information sent from the information processing device 10 on the display unit 25, for example.

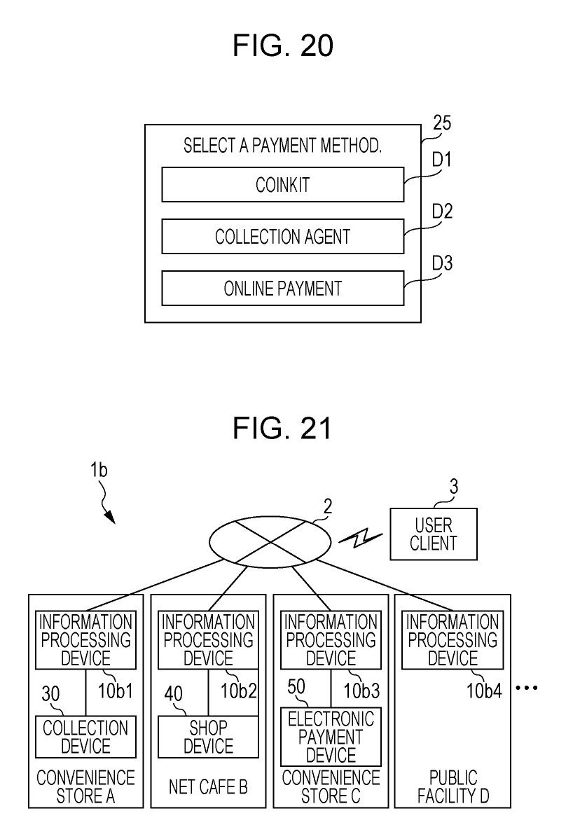

FIG. 20 is a diagram illustrating an example of displayed notification information. In this example, the character string “Select a payment method.” and operating element images D1, D2, and D3 that include the character strings “Coinkit”, “Collection agent”, and “Online payment” are displayed on the display unit 25. When the user selects one of the operating element images, the output device 20 reports the payment method corresponding to the selected operating element image to the information processing device 10. The sending unit 104 of the information processing device 10 sends charge information to a destination depending on the reported payment method, or in other words, the payment method selected by the user. As a result of the forwarding unit 202 of the output device 20 forwarding charge information sent in this way to the destination for that charge information, a charge process is conducted via the payment method selected by the user. In his exemplary modification, the user additionally selects one payment method from among multiple payment methods selected by the selecting unit 103, and payment is conducted by that payment method. Accordingly, user judgment is added to the selection of a payment method.

[3-2] Providing a Service by Information Processing Device

In each of the foregoing exemplary embodiments, an output device provides a pay service to a user, but an information processing device may also provide a pay service to a user.

FIG. 21 is a diagram illustrating an example of an overall configuration of an information processing system according to the present exemplary modification. FIG. 21 illustrates an information processing system 1b provided with information processing devices 10b1, 10b2, 10b3, and 10b4 (designated the information processing devices 10b when not being individually distinguished) in addition to the output devices 20a, 20b, 20c, and 20d illustrated in FIG. 1. The information processing devices 10b are equipped with a hardware configuration shared in common with the output devices 20 illustrated in FIG. 2.

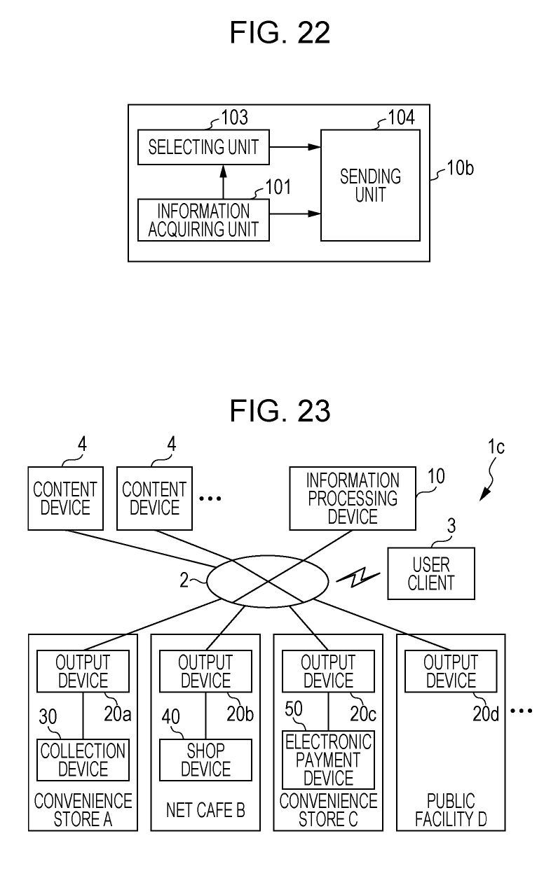

FIG. 22 is a diagram illustrating an example of a functional configuration of an information processing device 10b. The information processing device 10b is equipped with an information acquiring unit 101, a selecting unit 103, and a sending unit 104. The information acquiring unit 101 acquires information indicating details of a pay service provided by the device itself (in this exemplary modification, service details information) as fee calculation information. From among the charge processes illustrated from FIG. 11 to FIG. 15, the information processing device 10b conducts the operation that an output device 20 conducted in the charge process in order to pay by a payment method available for use at the device itself. Stated differently, the information processing device 10b not conducting operation that was conducted by an output device 20 means that the payment method corresponding to that charge process is not available for use. In other words, since the information processing device 10b knows which payment methods are available for use at the device itself, specification thereof is omitted, and the specifying unit 102 is not provided.

The selecting unit 103 selects at least one or more payment methods on the basis of influence information from among multiple payment methods available for use at the device itself. Although the sending unit 104 transmits charge information together with a forwarding request in each of the foregoing exemplary embodiments, in this exemplary modification, a forwarding request is not transmitted, and charge information only is transmitted to a destination (the collection device 30, the shop device 40, the electronic payment device 50, the image forming unit 26, and the display unit 25) depending on the selected payment method. Even in this case, respective charge information reaches a destination. Likewise in this exemplary modification, since the selection of a payment method and the sending of charge information are conducted, payment by the user takes less time and effort when there are multiple payment methods compared to the case in which the selection of a payment method and the sending of charge information are not conducted.

[3-3] Content Data Provider

In each of the foregoing exemplary embodiments, an information processing device provides content data provided by a pay service, but the configuration is not limited thereto, and content data may also be provided from another device.

FIG. 23 is a diagram illustrating an example of an overall configuration of an information processing system according to the present exemplary modification. FIG. 23 illustrates an information processing system lc equipped with multiple content devices 4 in addition to the respective devices illustrated in FIG. 1. The content devices 4 are devices that store content data output in a pay service. In this case, an output device 20 transmits service details information together to information processing device 10 as well as a content device 4, and in response the content device 4 transmits content data expressing content according to the details indicated by the service details information to the output device 20. Even in this case, since an information processing device 10 acquires service details information as fee calculation information and conducts the selection of a payment method and the sending of charge information, payment by the user takes less time and effort when there are multiple payment methods compared to the case in which the selection of a payment method and the sending of charge information are not conducted.

[3-4] Pay Services

In each of the foregoing exemplary embodiments, a service of outputting content to a medium is provided to a user, but services that do not involve such output may also be provided. For example, a service in which a user operates a kiosk terminal installed at a tourist attraction or the like to make a reservation for a nearby hotel or facility on the spot, a service in which a user operates a kiosk terminal installed at a convenience store or the like to purchase some kind of product on the spot, or the like may also be provided. Since these kiosk terminals are not equipped with a unit that outputs an image to a medium, collection agent and nearby collection agent are not available for use, but the other payment methods are available for use. For this reason, if a coinkit and an electronic payment device are connected to these kiosk terminals, for example, the selection of a payment method as above may be conducted.

[3-5] Payment Methods

The payment methods are not limited to those discussed earlier. For example, wire transfer to a bank account or direct debit from a bank account are also possible. In addition, if the pay service involves purchasing and shipping a product as discussed earlier, a payment method of paying at the time of product delivery may also be used. Basically, any method may be used as a payment method insofar as the method enables a user utilizing a pay service to pay the service fee.

[3-6] Operation According to Given Criteria

The tables used in the operation explained with FIGS. 6, 7, 8, and the like are not limited to that illustrated in these drawings. For example, the tables may have any number of rows equal to or greater than 2. Also, that which is arranged in ascending (or descending) order may be reordered in descending (or ascending) order, or reordered irrespectively of such an order. Furthermore, instead of using a table, the contents of each cell may be expressed by a numerical value, and a value computed using a numerical formula may be used. For example, in the case of the example in FIG. 8, a monetary amount corresponding to each payment method may be determined, with the priority ranking rising as the difference between that monetary amount and the service fee becomes smaller. Specifically, in the case in which the monetary amounts for “Coinkit” and “Electronic payment” are determined to be ¥500 and ¥1000, respectively, the priority ranking of coinkit is set higher than the priority ranking of electronic payment if the service fee is ¥700, since the difference is smaller for the monetary amount of coinkit. Meanwhile, the priority ranking of electronic payment is set higher than the priority ranking of coinkit if the service fee is ¥800, since the difference is smaller for the monetary amount of electronic payment. Basically, in these operations, it is sufficient for other criteria (in the example of FIG. 8, the priority ranking of payment methods) to be determined according to given criteria (in the example of FIG. 8, service fees).

[3-7] Categories of the Invention

Besides an information processing device, an output device, and an information processing system equipped with these devices, the present invention may also be interpreted as an information processing method for realizing a process carried out by an information processing device or output device. The process herein refers to the charge process illustrated in FIG. 11 and the like, for example. In addition, the present invention may be interpreted as a program for causing a computer such as an information processing device or an output device to function as the units illustrated in FIG. 4 or the like. The program may be provided in the form of a recording medium such as an optical disc with the program stored thereon, and may also be provided in a form such as causing a computer to download the program via a network such as the Internet, and install and make the program available for use.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an information acquiring unit that, in the case in which a pay service is provided to a user, acquires fee calculation information used to calculate a fee for the service;
a selecting unit that, in the case in which a plurality of payment methods exist for a fee calculated on the basis of fee calculation information acquired by the information acquiring unit, selects at least one payment method from among the plurality of payment methods, on the basis of influence information that potentially influences selection of the payment method; and
a sending unit that sends, to a destination depending on the payment method selected by the selecting unit, charge information used to charge a fee calculated on the basis of the acquired fee calculation information.

2. The information processing device according to claim 1, further comprising:
a specifying unit that, in the case in which the service is provided by any of a plurality of output devices, specifies which payment methods by which to pay a fee of the service are available for use on the output device that provided the service;
wherein, in the case in which the specifying unit specifies a plurality of payment methods, the selecting unit selects the plurality of payment methods as a plurality of payment methods for a fee calculated on the basis of the acquired fee calculation information.

3. The information processing device according to claim 1, wherein
the selecting unit selects the payment method using a fee of the service calculated on the basis of the acquired fee calculation information as the influence information.

4. The information processing device according to claim 1, wherein
the selecting unit selects the payment method using a time period when the service is provided as the influence information.

5. The information processing device according to claim 1, further comprising:
an attribute acquiring unit that acquires attribute information indicating attributes of a user;
wherein the selecting unit selects the payment method using an attribute indicated by attribute information acquired by the attribute acquiring unit as the influence information.

6. The information processing device according to claim 1, wherein
the selecting unit selects the payment method using a type of the service provided to the user as the influence information.

7. The information processing device according to claim 1, wherein
the payment methods include a method of paying the fee at a second location that differs from a first location at which the service is provided, and
the selecting unit selects the payment method using a distance between the first location and the second location as the influence information.

8. The information processing device according to claim 7, wherein
in the case in which the selecting unit selects a method of paying the fee at the second location, the sending unit sends, to the output device, the charge information including route data indicating a route to the second location.

9. The information processing device according to claim 1, wherein
the selecting unit selects a plurality of the payment methods on the basis of the influence information, and
the sending unit sends notification information for notifying the user to select one of a plurality of payment methods selected by the selecting unit, and sends the charge information to a destination depending on the payment method selected by the user.

10. An information processing method comprising:
in the case in which a pay service is provided to a user, acquiring fee calculation information used to calculate a fee for the service;
in the case in which a plurality of payment methods exist for a fee calculated on the basis of acquired fee calculation information, selecting at least one payment method from among the plurality of payment methods, on the basis of influence information that potentially influences selection of the payment method; and
sending, to a destination depending on the selected payment method, charge information used to charge a fee calculated on the basis of the acquired fee calculation information.

11. A non-transitory computer readable medium storing a program causing a computer to execute a process for processing information, the process comprising:
in the case in which a pay service is provided to a user, acquiring fee calculation information used to calculate a fee for the service;
in the case in which a plurality of payment methods exist for a fee calculated on the basis of acquired fee calculation information, selecting at least one payment method from among the plurality of payment methods, on the basis of influence information that potentially influences selection of the payment method; and
sending, to a destination depending on the selected payment method, charge information used to charge a fee calculated on the basis of the acquired fee calculation information.
